(19) United States
(12) Patent Application Publication
(10) Pub. No.: US 2007/0293388 A1
(43) Pub. Date: Dec. 20, 2007

(54) GLASS ARTICLES AND METHOD FOR MAKING THEREOF

(75) Inventors: Konstantin S. Zuyev, Beachwood, OH (US); Yan Zhou, Mayfield Village, OH (US)

Correspondence Address: MOMENTIVE PERFORMANCE MATERIALS INC.-Quartz;c/o DILWORTH & BARRESE, LLP, 333 Earle Ovington Blvd., Uniondale, NY, 11553, US

(73) Assignee: General Electric Company, Schenectady, NY (US)

(21) Appl. No.: 11/557,805

(22) Filed: Nov. 8, 2006

Related U.S. Application Data
(60) Provisional application No. 60/805,300, filed on Jun. 20, 2006.

(51) Int. Cl. C03C 3/06; C03C 3/076; C03C 3/083; C03C 3/085; C03C 3/087; C03C 3/078

(52) U.S. Cl. 501/54; 501/55; 501/68; 501/69; 501/70; 501/72

(57) ABSTRACT

A glass composition is characterized by having little batch-to-batch variations in the properties of the glass products made thereof. The glass composition contains 40 to 99 wt. % SiO₂ with a softening temperature ranging from 600° C. to 1650° C., and wherein the standard deviation of softening temperature measurements obtained from 10 or more randomly selected samples of glass articles produced from the lot is 10° C. or less.

### CROSS-REFERENCE TO RELATED APPLICATIONS

This application claims the benefits of U.S. patent application Ser. No. 60/805,300 filed Jun. 20, 2006, which patent application is fully incorporated herein by reference.

### FIELD OF THE INVENTION

The present invention relates to a glass composition and products made thereof, having very little variation in key properties within any given lot of the glass composition.

### BACKGROUND OF THE INVENTION

In glass applications such as liquid crystal panels, optical communication devices for instance optical filters and optical switches, recording medium, halogen and High Intensity Discharge (HID) lamps etc. the consistency of the glass substrate properties is quite critical. High-energy laser systems employ multiple large pieces of optical quality glass, sometimes thousands of large size laser glass pieces, and it is imperative for the pieces to have consistent optical quality. Glass compositions, similarly to fused quartz compositions, are characterized by a few fundamental properties affecting the manufacturing of or the properties of products employing the compositions, i.e., viscosity, % transmission, OH level to name a few. The effect of OH (hydroxyl) on viscosity of glass or quartz is widely known. FIG. 1, for instance, illustrates the viscosity curves of high purity quartz made with various OH concentrations. As seen from the Figure, viscosity of glass drastically drops with increased hydroxyl concentration. If glass or quartz has batch-to-batch or within-batch variations in the OH level, it will result in inconsistent manufacturability and product quality. From a lamp manufacturer's perspective, variations in the glass properties impact the yields of the high-speed lamp production lines, requiring undesirable and frequent adjustments made to the equipment to account for the variations in the glass properties.

Almost all arc discharge lamps and many high intensity filament lamps, such as tungsten-halogen lamps, emit ultraviolet (UV) radiation which may be harmful to human eyes and skin. As disclosed in U.S. Pat. Nos. 2,895,839; 3,148,300; 3,848,152; 4,307,315 and 4,361,779, lamps have been developed having a light source which emits both UV and visible light radiation enclosed within a vitreous envelope of fused quartz. U.S. Pat. Nos. 2,221,709; 5,569,979; 6,677,260 disclose fused quartz compositions containing UV-absorbing materials, or dopants as they are called, in the form of tubings or rods for use in making lamps, e.g., as lamp envelopes with properties to absorb UV radiation.

US Patent Publication No. 20040063564A1 discloses a composition useful for forming glass substrates for use in information recording medium, with desirable properties such as specific linear thermal expansion coefficient, fracture toughness, and a predetermined surface hardness. In applications for making bulk glass articles such as fiberglass, it is also useful to have consistency in the glass compositions to obtain the desired ranges of properties such as viscosities, humidity resistance, and the like. US Patent Publication No. 20020077243A1 discloses a composition for making glass fiber filters for use in micro-electronic clean room environments.

Due to the bulk volume of the feedstock making up the glass composition, there is a wide batch-to-batch variation in glass compositions as well as in the properties of products made from glass compositions of the prior art. It is important to have consistent properties in a glass composition such that products made thereof have properties that are uniform or varying in a narrow range. Additionally, the consistent properties allowing manufacturers to run production lines with minor or no adjustments in the line, for high productivity and consistently good glass products. The invention relates to a novel glass composition and a method for making glass products with uniform properties, as measured by the standard deviation.

### BRIEF SUMMARY OF THE INVENTION

In one aspect, the invention relates to a glass composition comprising a lot of glass articles, the glass composition containing 40 to 99 wt. % SiO₂, wherein the glass composition has a softening temperature ranging from 600° C. to 1650° C., and wherein the standard deviation of softening temperature measurements obtained from 10 or more randomly selected samples of glass articles produced from the lot is 10° C. or less.

In another aspect, the invention relates to a process for making a glass product comprising the steps of: a) forming a first blend of 0.02 to 0.50 wt. % of a dispersant with 1 to 25 wt. % of a dopant selected from the metal oxide group of Al₂O₃, TiO₂, CeO₂, Nd₂O₃, B₂O₃, BaO, SrO, CaO, MgO, Na₂O, K₂O, Li₂O, Sb₂O₃, Y₂O₃, CO₃O₄, Cu₂O, Cr₂O₃ and mixtures thereof, wherein the dispersant is a fumed metal oxide having a BET of 50-400 m²/g and a mean particle size of <1 μm; b) blending the first blend into 92-99 wt. % SiO₂ forming a quartz mixture; c) producing a melt of molten glass from the mixture; and d) passing the molten glass along a tool to form a glass product. In one embodiment, the glass product is in the form of a tubing, a rod, or a blank. In a second embodiment, the fumed metal oxide is selected from at least one of silica or a metal oxide already present in the dopant.

The invention further relates to a glass product, comprising 92-99 wt. % of SiO₂, 1 to 8 wt. % of a dopant selected from the metal oxide group of Al₂O₃, CeO₂, TiO₂, Nd₂O₃, B₂O₃, BaO, SrO, CaO, MgO, Na₂O, K₂O, Li₂O, Sb₂O₃, Y₂O₃, CO₄O₄, Cu₂O, Cr₂O, and mixtures thereof, and 0.02 to 0.50 wt. % of a fumed metal oxide having a BET of 50-400 m²/g and a mean particle size of <1 μm, and wherein the fumed metal oxide is SiO₂ or a metal oxide present in the dopant, wherein the viscosity of a plurality of products prepared from the same batch exhibits a standard deviation of less than 10° C.

### BRIEF DESCRIPTION OF THE DRAWING

FIG. 1 is a graph illustrating the change in the viscosity of high purity quartz glass as a function of OH concentrations.

FIG. 2 is a photograph comparing lamp envelopes made from the glass composition in one embodiment of the invention, i.e., 2 wire lamps on the right vs. 2 lamp envelopes made from a glass composition in the prior art (lamps on the left).

FIG. 3 is a graph comparing the variations in UV transmission data for samples from the glass products of the invention as made from the same lot vs. samples from glass products made from a composition in the prior art.

FIG. 4 is a graph comparing the variations in UV transmission data over a range of 200-800 nm, for samples from the glass products of the invention as made from the same lot vs. samples from commercially available glass products in the prior art.

FIG. 5 is a graph comparing the average OH concentration and standard deviation of an embodiment of the glass composition of the invention vs. reference samples from commercially available glass products in the prior art.

FIG. 6 is a photograph comparing a glass “puck” made from the glass composition in one embodiment of the invention vs. a glass puck made from a glass composition in the prior art, particularly with respect to degree of clarity (or transmission through the glass).

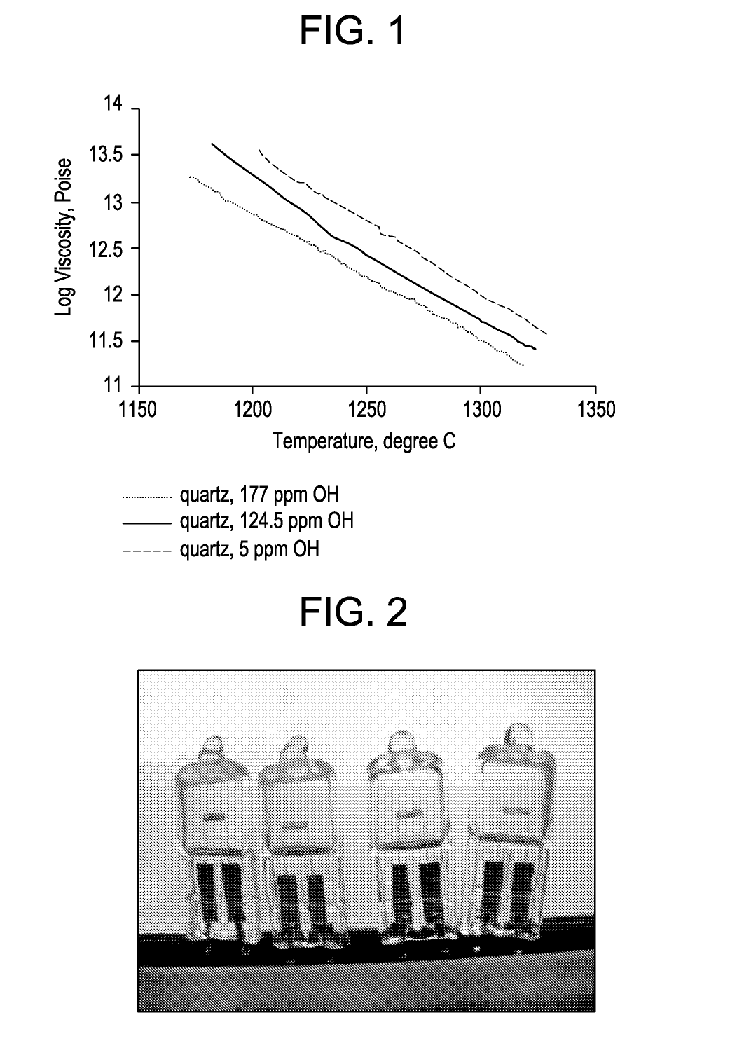

### DETAILED DESCRIPTION OF THE INVENTION

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases.

As used herein, the term “functionalized” may be used interchangeably with “surface functionalized,” “functionalized surface,” “coated,” “surface treated,” or “treated,” referring to the coating of the silica and dopant components with the dispersing agent of the invention. As used herein, “coating agent” is used interchangeably with “dispersing” agent.

Although the terms may be used to denote to compositions or articles of different materials (different silica concentrations), as used herein, the term “glass” may be used interchangeably with “quartz glass” or “quartz” or “fused quartz,” referring to a composition, a part, a product, or an article formed by melting a mixture comprising natural or synthetic sand (silica). Either or both natural or synthetic sand (silica) can be used in the composition of the invention, and the term is used to denote compositions comprising either naturally occurring crystalline silica such as sand/rock, synthetically derived silicon dioxide (silica), or a mixture of both. The term “sand” may be used interchangeably with silica, denoting either natural sand or synthetic sand, or a mixture of both.

As used herein, the term “lot” when applied to a batch process for making the glass products of the invention, refers to glass articles made from a single batch of sand feed of at least 100 kg. in total composition of sand and other additives. When applied to a continuous process of making glass products, the term lot refers to the glass articles having a total weight of at least 100 kg., as continuously produced from a process.

In one embodiment, the invention relates a glass composition with minimum variations in the properties of articles formed from the same lot of the composition, e.g., fiberglass, tubings, rods, blanks, plates, etc., via the use of at least a dispersing/coating agent that helps the dopant(s) adhere to the sand grains. The dispersant maximizes the composition homogeneity within the same lot, such that the articles or parts manufactured from the same lot have minimum variations in properties such as viscosity, OH—, and the like. The articles made from the composition of the invention with minimum variations in properties can be subsequently melted, drawn, formed or tailored into a final glass product.

Sand Component: Depending on the final applications, the sand (SiO₂) feed can be either synthetic sand, natural sand, or a mixture thereof. In one embodiment, the amount of SiO₂ ranges from 40 to 75%. In a second embodiment, the amount is from 70 to 95 wt. %. In a third embodiment, the glass comprises a light-transmissive, vitreous composition with a SiO₂ content of at least 90 wt. %. In a fourth embodiment of a quartz composition with a high melting point, at least 95 wt. % SiO₂ is used. In a fifth embodiment, the amount of SiO₂ ranges from 40 to 99%.

Dispersing Agent Component. In one embodiment, the agent is a fumed metal oxide selected from the group of consisting of alumina, silica, titania, ceria, neodymium oxide, and mixtures thereof, having a BET value of 50 m²/g to 1000 m²/g and a particle size of less than 25 microns. Fumed metal oxides are produced using processes known in the art, in one example, the hydrolysis of suitable feed stock vapor (such as silicon tetrachloride for fumed silica) in a flame of hydrogen and oxygen.

The surface area of the metal oxides may be measured by the nitrogen adsorption method of S. Brunauer, P. H. Emmet, and I. Teller, J. Am. Chemical Society, Volume 60, Page 309 (1938) and is commonly referred to as BET. In one embodiment, the dispersing agent has a BET of 100 m²/g to about 400 m²/g. In a second embodiment, the fumed metal oxide dispersing agent has a mean particle size of 15 μm or less. In a third embodiment, the fumed metal oxide has a mean particle size of less than 1.0 μm. In a fourth embodiment, the fumed metal oxide has a mean particle size of 0.1-0.5 μm with a BET value of 50 m²/g to 100 m²/g.

The dispersing agent is added to the glass composition in an amount ranging from 0.02 to 0.50 wt. % (based on the total weight of the final glass composition). In one embodiment, dispersant is added to the sand mixture in an amount ranging from 0.04 to 0.30 wt. %. In a second embodiment, from 0.05 to 0.15 wt. %. In a third embodiment, from 0.05 to 0.10 wt. %.

In one embodiment, it is added directly to the glass composition along with the dopants. In a second embodiment, it is pre-mixed with at least one of the dopant(s) or a portion of the dopant(s), forming a master batch, which is subsequently added to the sand mixture. In a third embodiment, the dispersant is mixed with part or all of the selected dopant(s) forming a master batch, which master batch is subsequently added to the sand mixture and other dopants. In a fourth embodiment, the dispersant is mixed with all or some of selected dopants as well as some of the sand to form a master batch, which master batch is subsequently added to the final sand mixture.

In one embodiment, the dispersing agent is untreated fumed silica. In a second embodiment wherein Al₂O₃ is used as a dopant, the dispersing agent is fumed alumina. In a third embodiment wherein CeO₂ is added as a dopant, fumed ceria is used as a dispersing agent. In a fourth embodiment wherein one of the dopants used is Nd₂O₃, a mixture of fumed neodymium oxide and fumed silica is used as the dispersing agent. In yet another embodiment and regardless of the dopant(s) used, the dispersant is selected from fumed metal oxides with little adverse impact to the properties of the glass products, i.e., the group consisting of fumed alumina, silica, titania, ceria, neodymium oxide, and mixtures thereof

Dopant Component(s): Depending on the end-use applications and the desired properties, e.g., high-intensity discharge lamps, tungsten-halogen lamps, automotive glazing, optical lenses, etc., a number of different dopants and mixtures thereof may be added to the base silicate or borosilicate glass. Examples of dopants include but not limited to metals, metal oxides, and alkali metal oxides known in the art, in an amount of 0.1-25% by weight for each dopant.

In one embodiment, the dopants are be added to glass to change its color and transmission characteristics amongst other properties. In a second embodiment, the total amount of dopants is in the range of 0.1 to 10 wt. %. In a third embodiment, each of the dopant ranges from 0.1 to 8 wt. %. In a third embodiment, each of the dopant ranges from 0.1 to 5 wt. %.

In one embodiment, the dopant is neodymium oxide Nd₂O₃. Neodymium has been long-known as a coloring agent like the other rare-earth elements, it possesses an absorption spectra that extends over both the visible and invisible regions, transferring practically unchanged to base compounds, such as glasses. Neodymium absorbs light in the yellow region of the visible spectrum, between about 568 and 590 nm. As a result, light passing through neodymium containing glass accentuates the red and green tones in the surrounding environment. Furthermore, neodymium-containing glass provides an increase in visibility during foggy weather.

In a second embodiment, the dopant is a boron oxide B₂O₃. The amount of B₂O₃ may be carefully tailored to impart a sufficient low viscosity to the glass to effect easy melting thereof, but without raising the expansion of the glass. In a third embodiment, the dopant is an alkali oxide, e.g., Na₂O, K₂O, or Al₂O₃, or a mixture thereof, in a borosilicate composition (SiO₂+B₂O₃) for a glass with low expansion coefficients and lower softening temperature. In a fourth embodiment, the dopant is CeO₂ in an amount of 0.1-5% by weight. Cerium is the only rare-earth element that absorbs UV radiation while exhibiting no absorption in the visible region of the spectrum. In yet a fifth embodiment, titanium or titanium oxide may be added, wherein the addition of titanium sometimes produces yellowish-brown glass. In a sixth embodiment, the dopant comprises europium oxide Eu₂O₃ by itself, or in combination with other dopants such as TiO₂ and CeO₂. In seventh embodiments, dopants such as CaO and/or magnesium oxide MgO may be added to give stability to the composition.

In one embodiment of a glass composition containing 95-99.9 wt. % SiO₂ and excluding the dispersing agent(s), dopants are added in an amount ranging from 0.1 to 5 wt. % Al₂O₃ and other impurities in an amount of not exceeding 150 ppm (total). In a second embodiment, the composition comprises 95-99.9 wt. % SiO₂, 0.1 to 5 wt. % Al₂O₃ as a dopant, 0.1 to 400 ppm titanium (element), 0.1 to 4000 Cerium (in elemental form or CeO₂), and other impurities not exceeding 150 ppm (total). In a third embodiment, the composition comprises 95 to 99.9 wt. % SiO₂, 0.1 to 5 wt. % Al₂O₃ as a dopant, 0.1 to 400 ppm Titanium (element), 0.1 to 4000 Cerium (in elemental form or CeO₂), 0.01 to 2 wt. % Nd₂O₃, and other impurities not exceeding 150 ppm (total).

In yet another embodiment and excluding the dispersing agent(s), the composition consists essentially of in weight %, 90.5-95.7% SiO₂, 2.8-3.0% B₂O₃, 0.7-1.7% Al₂O₃, 0.4-4.5% Nd₂O₃, and 0.1-1% CeO₂, for use as envelopes for tungsten-halogen lamps and other high temperature lamps. In yet another embodiment for making halogen lamp envelopes, and excluding the dispersing agent, the composition consists essentially of in weight %, 55-66% SiO₂, 0-13% B₂O₃, 14-18% Al₂O₃, 0-13% BaO, 0-4 SrO, 0-13% CaO, 0-8% MgO, 0.4-4.5% Nd₂O₃, and 0.1-1% CeO₂. In another embodiment of a glass composition for sealed-beam incandescent headlights, the composition excluding the dispersing agent consists essentially of 64-85% SiO₂, 11-28% B₂O, 0.5-8.5% Al₂O₃, 0-3.5% BaO, 0-1.5% CaO, 0-7.5% Na₂O, 0-9.5% K₂O, 0-1.5% Li₂O, 0-1.5% Sb₂O₃, 0.4-4.5% Nd₂O₃, and 0.1-1% CeO₂.

In one embodiment for a glass composition for the absorption of red light in the range of 560-620 nm, and excluding the amount of added dispersant, the composition comprises 95-110 parts by weight SiO₂, 0.5 to 1.2 parts by weight CeO₂, 0.5 to 2.5 parts be weight of Nd₂O₃, 0.1 to 1 parts be weight of Al₂O₃, optionally 0.001 to 0.1 parts by weight of Eu₂O₃, 0.001 to 0.1 parts be weight of TiO₂, 0.001 to 0.5 parts by weight of BaO.

In one embodiment for a glass composition for making clean room HEPA and ULPA filters and excluding an amount of 0.05 to 0.10 wt. % of fumed silica as dispersants, the composition comprises <1 wt. boron; 5.5-18 wt. % barium oxide; 10-14.5 wt. % alkali oxide; 4-8 wt. % alumina; 1-9 wt. % alkaline earth oxide; 2-6 wt. % zinc oxide; 0.1-1.5 wt. % fluorine; and the balance silica. In yet another embodiment for a glass composition for glass components of lamps with excellent electrical insulation properties, excluding 0.02 to 0.50 wt. % of fumed alumina as a dispersant, the composition comprises 55-80 wt % SiO₂; 0.5-5 w t % Al₂O₃; 0-5 wt % B₂O₃; 2-15 wt % Na₂O; 0-5 wt % Li₂O; and 1-15 wt % K₂O, with the total content of Na₂O, Li₂O, and K₂O falling within a range of 3-25 wt %. In yet another glass composition for optical applications, e.g., graded index lenses, excluding 0.02 to 0.50 wt. % of fumed silica as a dispersant, the composition comprises 40-65 mol % SiO₂; 1-10 mol % TiO₂; up to 22 mol % MgO; 2-18 mol % Li₂O; 2 to 20 mol % Na₂O; and 1-15 mol % of any of CaO, SrO and BaO.

Process for Making Glass Compositions/Products: The use of dispersants in the composition of the invention facilitates the blending of the dopants in the sand feed, and thus the homogeneity of glass products made. The composition can be made by via a batch method (one-at-a-time melting process) or a continuous melting method.

In one embodiment of a batch process, the glass products are made from batches of sand feed in the form of barrels or bags of sand, with each barrel or bag having a weight of at least 100 lbs. In another embodiment, glass products are made from batches of at least 100 kg. of sand feed for each batch, with the sand being supplied in barrels of sizes of 100 kg. In yet another embodiment, the sand is supplied in batches of 300 lbs. for each bag or barrel, thus making glass articles out of single batches of at least 300 lbs. each.

In one embodiment, the dispersing agent, i.e., the fumed metal oxide(s) such as fumed silica, fumed alumina, etc., is first mixed with 20-100% of a single dopant, a few dopants, or all of the dopant(s), forming a master batch or concentrate. The fumed metal oxide dispersing agent can be the same or different metal oxide(s) as the dopant material(s). The mixing/blending may be conducted in a processing equipment known in the art, e.g., blenders, high intensity mixers, etc, for a sufficient amount of time for the dopants to be thoroughly coated with the dispersing agent. In one embodiment, a mixture of fumed silica as the dispersing agent is mixed with dopants such as Al₂O₃, CeO₂, Nd₂O₃, etc., in a Turbula® mixer between 1 to 5 hours forming a master batch. Though not bound by theory, it is believed that the fumed silica acts as a sand grain “coating” agent and attracts smaller particles of dopant such as aluminum oxide, thus providing a more uniform mix.

In the next step, the master batch containing the coated dopant(s) is added to the natural/synthetic sand feed and the remainder of the uncoated dopants, if any, and mixed thoroughly in an equipment such as a tumbler, a sand muller, etc.

In one embodiment of the invention, the homogenous mix is calcined or heated at a temperature between 500-1500° C. for a sufficient period of time, e.g., for ½-4 hrs, to dry out the sand. The mixture is subsequently fused at a sufficiently high temperature to form glass products. The temperature depends on the glass composition, and in quartz compositions (having >95% SiO₂), the mixture is fused at a temperature of >2000° C. and ranging to 2500° C., giving a vitreous material. In one embodiment, the mixture is continuously fed into a high temperature induction (electrical) furnace operating at temperatures in the range of 1400-2300° C., forming tubes and rods of various sizes. In another embodiment, the mixture is fed into a mold wherein flame fusion is used to melt the composition, and wherein the molten mixture is directed to a mold forming the glass particle.

In one embodiment wherein the glass product is in the form of continuous tube drawing, e.g., the tubings can be made by any process known in the art including the Danner process, the Vello process, a continuous draw process or modified processes thereof.

Glass Products from Composition of the Invention. Although not bound by theory, but it is believed that the dispersing agent in the form of fumed metal oxide with large surface areas functions as a mixing agent, helping the dopants stick or adhere to the sand grains, thus allowing a homogeneous mix and subsequently, glass products having very little variations in properties for products resulting from the same batch of sand. The glass products can be of an intermediate form of glass tubing, for use in manufacturing halogen lamb bulbs or water treatment lamps; solid glass rods or performs for making lamp envelopes; blanks, glass plates or sheets for automotive glazing. The glass products can be of a final bulk form such as glass fiber.

In one embodiment, the tubings have sizes ranging from 1 to 500 mm outside diameter (OD), with a thickness ranging from 1 to 20 mm depending on the size of the tubing. The length of the tubings ranges from 24 to 60″ for tubings with O.D of less than 100 mm and 24 to 96″ for tubings with OD of greater than 100 mm.

In another embodiment of making glass preforms or rods using processes known in the art, including a continuous draw process of at least two steps. In the first step, an elongated, consolidated preform having an aperture is drawn to a reduced diameter preform. The second step involves drawing the reduced diameter preform into a rod at a lower temperature than the first step to reduce the formation of inclusions in the glass rod during drawing. In one example, the rods have OD ranges from 0.5 mm to 50 mm. In one embodiment, the rods are made in a draw process

In one embodiment of a continuous process, e.g., making glass plates for use in automotive applications, after the raw materials are admixed and melted, the melt is feed to a conventional float glass furnace and subsequently into a molding forming the final product.

Uniform Properties of Glass Products: In one embodiment, the glass products of the invention are characterized as having uniform properties for glass articles produced from the same lot, i.e., articles or pieces produced from the same mixing batch with each batch employing a minimum size of at least 100 kg. of sand, or glass articles continuously produced from a continuous process with a total weight of at least 100 kg.

Uniform properties means little variations in the properties of the glass pieces or products from the same lot are measured. The properties range from chemical properties such as OH level to physical properties such as viscosity, transmission, strength, and color measurement, softening point, annealing point, etc.; thermal properties such as coefficient of thermal expansion; mechanical properties such as compressive strength, etc. As used herein a plurality of products means at least 10 samples, randomly selected from products/pieces made from the same lot.

Melting temperature, softening temperature, strain temperature, and annealing temperature respectively vary according to the glass composition, i.e., ranging from as low as 600° C. as softening point for lead borate glass to 1650° C. for fused silica. The glass articles of the invention have different working temperatures depending on the amount of silica present in the composition. However, they are all characterized as varying little in the melting temperature, softening temperature, strain temperature, and annealing temperature for glass articles made from the same lot. In one embodiment, the glass articles made from the same lot have a standard deviation σ of less than 10° C. in their melting point, softening point, bending point, and annealing point respectively, as measured from 10 or more randomly selected samples of glass articles produced from the same lot. In a second embodiment, the standard deviation is less than 5° C. variation in the melting, softening, bending, and annealing temperatures respectively, from measuring at least 10 randomly selected samples.

In one embodiment, glass articles made from the same lot have an average annealing temperature in the range of 1000-1250° C. (corresponding to a log viscosity of 13.18 Poise), with a standard deviation σ of less than 10° C. In a second embodiment, the glass articles have a standard deviation σ of less than 5° C. for articles made from the same lot.

In one embodiment, the glass articles produced from the same lot have a standard deviation σ of 10 ppm in terms of the average OH concentration. In one embodiment, the glass articles have an average OH concentration of less than 100 ppm, with a standard deviation σ of less than 10 ppm. In another embodiment, the glass has an average OH concentration of <50 ppm, with σ value of less than 5 ppm for glass articles from the same batch. In yet another embodiment, glass articles from the same lot have an average OH concentration of <30 ppm, with σ value of less than 5 ppm. In a fourth embodiment, glass articles from the same lot have an average OH concentration of <20 ppm, with σ value of less than 3 ppm.

Glass articles made from the compositions of the invention are also characterized as having excellent dimensional control/stability, e.g., with little variations in the dimensions of the finished articles made from the same mold and out of the same lot. Generally, the dimensional accuracy (moldability) of a glass product can be accurately judged by process capability (Cpk). Here, “process capability” indicates the degree of quality that is achieved when the process is standardized, and causes for abnormality are removed, whereby the process is kept in a stable condition. In one embodiment, dimensions of glass articles are measured using a micrometer and calipers for at least three dimensions, length, thickness, and width for glass articles in the form of a plate. In a second embodiment, dimensions along the line of length, thickness (of a tubing) and diameter are measured. In one embodiment, the glass articles of the invention are characterized as having a Cpk (process capability index) of >1.50 in all three quantified dimensions. In a second embodiment, the glass articles have a Cpk of >1.33 for articles made from the same lot. In yet another embodiment, the glass articles are measured in terms of their outer diameter, wall thickness, and ovality (variation in the outer diameter around the circumference), and wherein the articles have a CpK of >1.33 for articles from the same lot.

In one embodiment the glass articles as produced from the same lot of the invention have an average coefficient of thermal expansion from 25° C. to 320° C. of 0.54*10⁻⁶/K to 5.5*10⁻⁷/K with a standard deviation σ of <0.5*10⁻⁷/K. In one embodiment, the glass articles have an average coefficient of thermal expansion from 25° C. to 320° C. of less than 7.0*10̂-7/K, with a standard deviation σ of <7*10⁻⁸/K.

In one embodiment, the glass articles made from the same lot of the present invention have a refractive index ranging from 1.40 to 1.68, with a standard deviation for glass articles made from the same lot of less than 0.001. In one embodiment, the glass articles have a refractive index ranging from 1.450 to 1.480 with a standard deviation of less than 0.0001 for glass articles made from the same lot.

In one embodiment, the glass articles of the invention comprising 95-99.995 wt. % of high purity silicon dioxide display a visible transmission of above 90% in 400-800 nm wavelength range, with a standard deviation of less than 2% for glass articles produced from the same lot. In a second embodiment, the glass articles display a visible transmission of above 90% in 400-800 nm wavelength range and a standard deviation of less than 0.5% for glass articles produced from the same lot.

Applications and Articles Employing Glass Products: In one embodiment, the molten glass composition is molded/formed into a final product such as glass plates or containers. In another embodiment for use in lamp products, e.g., lamp envelopes of tungsten-halogen lamp systems or lamp sleeves for tungsten-halogen lamps and other high temperature lighting devices (“high intensity discharge lamps”), the molten glass composition is made into intermediate glass products such as rods or tubings prior to being formed into the final glass application as lamp envelopes or sleeves.

In one embodiment, the composition is used in applications where high contrast and enhanced visible properties of transmitted or reflected visible light can be a benefit. Such uses include, for example, opthalmic glass for eyewear, such as sunglasses, or as glass hosts for lasers. In yet another embodiment, the glass can be made into computer screens with enhanced contrast properties can lessen visual discomfort, or rear-view mirrors to reduce glare. The glass products with uniform properties of the invention can also be used in applications such as containers for medical, chemical, and pharmaceutical products such as ampoules, bottles, reagent containers, test tubes, titration cylinders and the like. In another embodiment, the product is used in applications such as automotive glazing. The glass composition can also be used in bulk glass products such as fiberglass.

### EXAMPLES

Examples are provided herein to illustrate the invention but are not intended to limit the scope of the invention.

In the examples, fumed silica is commercially available from Matteson-Ridolfi Inc. as Cab-O-Sil M5, with a B.E.T. surface area of 200 m²/g and average particle (aggregate) size of 0.2-0.3 μm. The sand used is a natural sand having a purity level of at least 99.99%, which is commercially available from a number of sources.

### Example 1

A glass composition is made with 96 wt. % high purity silicon dioxide, 4 wt. % Al₂O₃ as a dopant, and with other impurities kept at below 150 ppm. The Al₂O₃ dopant is first coated with 0.08 wt. % of fumed silica prior to being mixed into the batch of SiO₂. The composition is then fused in a high induction furnace at 2000° C., forming quartz tubings (labeled as LSPG 1 in subsequent examples).

### Example 2

A UV-blocking glass composition is made with 96 wt. % high purity silicon dioxide, 4 wt. % Al₂O₃, 200 ppm of titanium, and 500 ppm of CeO₂, with other impurities kept at below 150 ppm. The Al₂O₃, titanium, CeO₂ dopant mixture is first coated with 0.05 wt. % of fumed silica prior to being mixed into the batch of SiO₂. The composition is then fused in a high induction furnace at 2000° C., forming quartz tubings (labeled as LSPG 2 in subsequent examples).

### Example 3

Random samples from sections of fused quartz tubings made from the quartz glass composition LSPG1 of Example 1 were measured for OH concentration (in ppm). Random samples were also obtained from commercially available fused quartz glass tubings sold as Vycor® 7907, Vycor® 7913, and Vycor® 7921 from Corning Incorporated of Corning, N.Y. and measured for OH concentration. Standard deviations were measured and the results are as follows in Table 1:

TABLE 1

| | Example 1 | Vycor 7907 | Vycor 7913 | Vycor 7921 |
|---|---|---|---|---|
| | Tubing | Tubing | Tubing | Tubing |
| | 39.15 | 241.56 | 124.46 | 118.83 |
| | 39.82 | 277.49 | 153.54 | 123.66 |
| | 36.66 | 267.46 | 110.11 | 105.43 |
| | 36.09 | 267.21 | 130.27 | 89.35 |
| | 36.14 | 251.51 | 116.89 | 119.28 |
| | 36.21 | 268.57 | 212.04 | 122.62 |
| | | | 224.87 | |
| | | | 224.38 | |
| | | | 210.58 | |
| | | | 91.48 | |
| | | | 83.6 | |
| | | | 77.07 | |
| | | | 66.99 | |
| | | | 90.45 | |
| Ave. OH | 37.345 | 262.300 | 136.909 | 113.195 |
| Stand. Dev. | 1.683 | 13.171 | 57.905 | 13.387 |

### Example 4

Lamp envelopes were made out of randomly selected fused quartz tubings made from the composition LSPG 1 of Example 1 and the Vycor® 7913 tubings. No adjustments were made to the lamp manufacturing line to account for the differences in the physical and chemical properties of the tubings. FIG. 2 is a photograph comparing the lamps made from the quartz composition of the invention (two lamps on the right hand side) and lamps made from the composition of the prior art (two lamps on the left side of the picture), showing deformity in the two lamps made from a composition of the prior art.

### Example 5

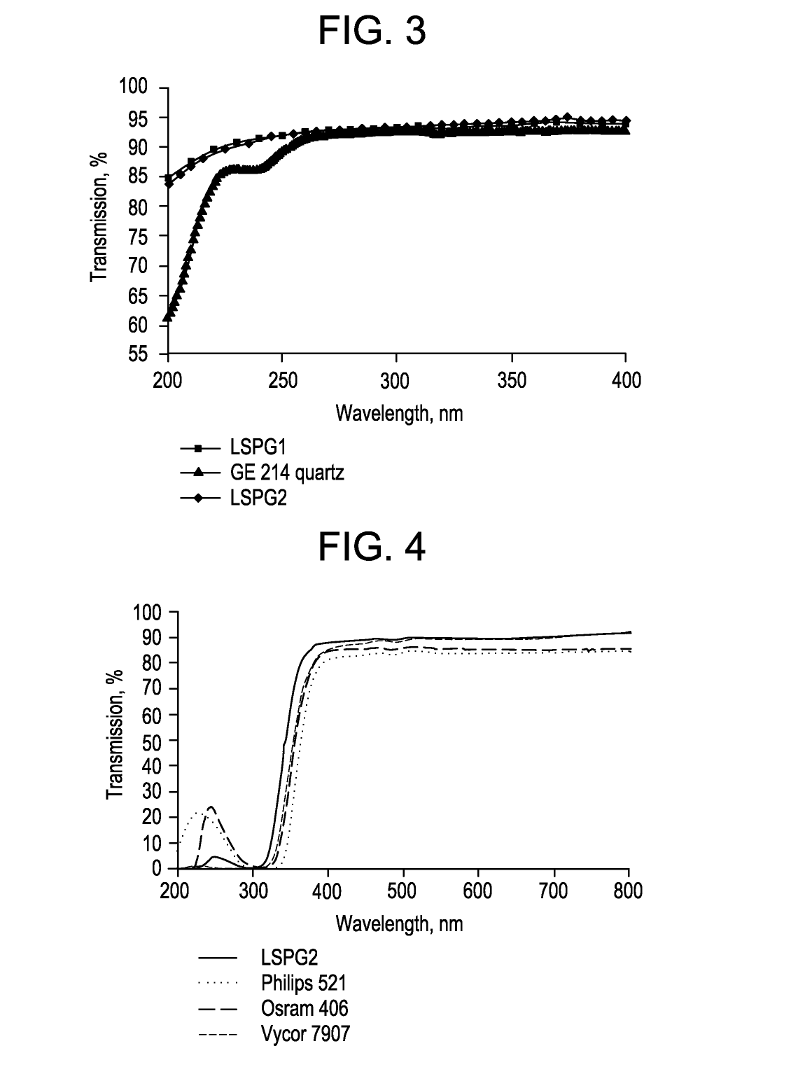

UV transmittance data between 200 to 400 nm were measured for samples of quartz tubings made from: a) compositions LSPG1 and LSPG2 of Examples 1-2; b) commercially available GE214 natural quartz from GE Quartz, Inc. of Ohio, FIG. 3 is a graph comparing the UV transmission data, showing that the quartz glass products of the invention as made from the same batch have a much narrower UV transmission variation band compared to a quartz glass composition of the prior art (GE214 quartz).

Also as illustrated, the quart glass products of the invention absorb at least 90% of UV radiation between 250 to 400 nm, and at least 87% of the UV radiation between 200 to 400 nm. Although not measured/illustrated in FIG. 3, it is noted that publicly available transmission data for Vycor 7913 shows a significant jump from <5% to about 90% from 200 to 300 nm for Vycor 7913, as compared to a narrow variation of less than 10% for the compositions of the invention in the range of 200 to 300 nm.

### Example 6

UV transmittance data between 200 to 800 nm were measured for samples of quartz tubings made from composition LSPG2 of Example 2 and commercially available products including Osram 406, Philips 521, and Vycor 7907. FIG. 4 is a graph comparing the UV transmission data for the various samples. As noted, the transmission data for the sample of the invention shows little variation in the 200-300 nm range compared to the samples of the prior art.

### Example 7

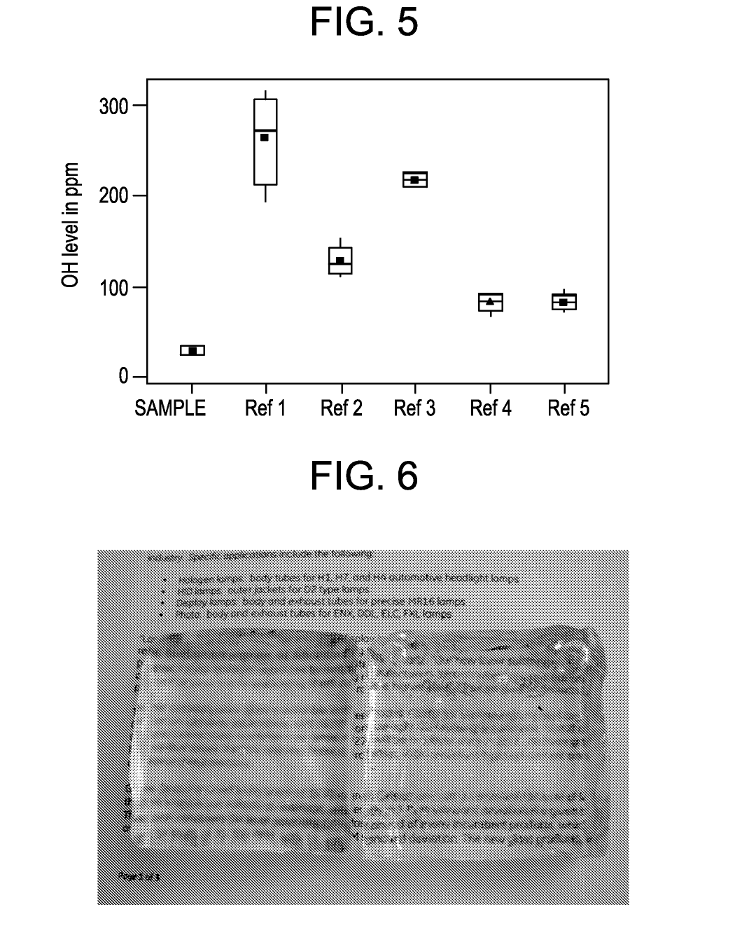

OH concentrations were measured for samples of quartz tubings made from composition LSPG2 of Example 2 and commercially available products including Osram 406, Philips 521, Vycor 7907, and Philips low viscosity glass. FIG. 5 is a graph comparing the OH concentration in ppm for the composition Example 2 vs. the various prior art glass samples (commercially available glasses indicated as reference samples 1-5). As shown in the Figure, the sample of the invention has a much lower average OH level and standard deviation compared to the samples of the prior art.

### Example 8

Glass pucks having dimensions of 4″ by 4″ by 1″ (in thickness) are fused from: 1) comparative glass composition containing 96 wt. % high purity silicon dioxide, 4 wt. % Al₂O₃ as a dopant, and with other impurities kept at below 150 ppm; and 2) a composition of the invention, LSPG1 composition of Example 1 with 0.08 wt. % of fumed silica. FIG. 6 is a photograph comparing the two glass pucks side by side, comparative glass puck on the left of the picture and the LSPG1 glass puck on the right. As shown, the glass on the right has a greater degree of clarity (or transmission through the glass) compared to the glass on the left, with the letters underneath the LSPG1 puck on the right appear to be more clear/easier to read.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All citations referred herein are expressly incorporated herein by reference.

1. A glass composition comprising a lot of glass articles, the glass composition containing 40 to 99 wt. % SiO₂, wherein the glass composition has a softening temperature ranging from 600° C. to 1650° C. and a standard deviation σ of less 10° C. when the softening temperature is measured from 10 or more randomly selected samples of glass articles in the lot.

2. The glass composition of claim 1, wherein the standard deviation σ of the softening temperature is 5° C. or less, as measured from 10 or more randomly selected samples of glass articles in the lot.

3. The glass composition of claim 1, wherein the glass composition contains 90 to 95 wt. % SiO2, wherein the glass composition has an annealing temperature in the range of 1000-1250° C. and a standard deviation σ of less than 10° C. when the annealing temperature is measured from 10 or more randomly selected samples of glass articles in the lot.

4. The glass composition of claim 1, wherein the standard deviation σ of the annealing temperature is 5° C. or less, as measured from 10 or more randomly selected samples of glass articles in the lot.

5. The glass composition of claim 1, wherein the glass composition has an OH— concentration of less than 100 ppm, and a standard deviation σ of less than 10 ppm when the OH concentration is measured from 10 or more randomly selected samples of glass articles in the lot.

6. The glass composition of claim 1, wherein the glass composition has an OH— concentration of less than 50 ppm, and a standard deviation σ of less than 5 ppm when the OH concentration is measured from 10 or more randomly selected samples of glass articles in the lot.

7. The glass composition of claim 6, wherein the glass composition has an OH— concentration of less than 30 ppm, and a standard deviation σ of less than 5 ppm when the OH concentration is measured from 10 or more randomly selected samples of glass articles in the lot.

8. The glass composition of claim 7, wherein the glass composition has an OH— concentration of less than 20 ppm, and a standard deviation σ of less than 3 ppm when the OH concentration is measured from 10 or more randomly selected samples of glass articles in the lot.

9. The glass composition of claim 1, wherein the glass articles are processed from a standardized process having a process capability CpK of >1.33.

10. The glass composition of claim 9, wherein the glass articles are processed from a standardized process having a process capability CpK of >1.50.

11. The glass composition of claim 1, wherein the composition comprises 40 to 99 wt. % of SiO₂, 0.1-25 wt. % of at least a dopant selected from the metal oxide group of Al₂O₃, CeO₂, TiO₂, Nd₂O₃, B₂O₃, CeO₂, BaO, SrO, CaO, MgO, Na₂O, K₂O, Li₂O, Sb₂O₃, and mixtures thereof, and 0.02 to 0.50 wt. % of a fumed metal oxide having a BET of 50-400 m²/g and a mean particle size of <1 μm, and wherein the fumed metal oxide is SiO₂ or a metal oxide present in the dopant.

12. The glass composition of claim 11, wherein the composition comprises 0.04 to 0.30 wt. % of the fumed metal oxide.

13. The glass composition of claim 12, wherein the composition comprises 0.05 to 0.15 wt. % of the fumed metal oxide.

14. The glass composition of claim 11, wherein the fumed metal oxide is first mixed with 20 to 100% of the at least a dopant forming a master batch, which is subsequently added to the SiO₂ of the glass composition.

15. The glass composition of claim 1, wherein the composition comprises 90 to 99 wt. % of SiO₂ and 0.1-8 wt. % of a dopant selected from the metal oxide group of Al₂O₃, CeO₂, TiO₂, Nd₂O₃, B₂O₃, CeO₂, BaO, SrO, CaO, MgO, Na₂O, K₂O, Li₂O, Sb₂O₃, and mixtures thereof

16. A process for making a glass product with reduced variations in its properties, the process comprises the steps of:
providing 40 to 99 wt. % of SiO₂ and 0.1-25 wt. % of at least a dopant selected from the metal oxide group of Al₂O₃, CeO₂, Nd₂O₃, B₂O₃, CeO₂, TiO₂, BaO, SrO, CaO, MgO, Na₂O, K₂O, Li₂O, Sb₂O₃, and mixtures thereof, wherein the dispersant is a fumed metal oxide having a BET of 50-400 m²/g and a mean particle size of <1 μm, and wherein the fumed metal oxide is SiO₂ or a metal oxide present in the dopant;
forming a first blend of 0.02 to 0.50 wt. % of a dispersant with 20% to 100% of the at least a dopant;
blending the first blend into the SiO₂ and any remainder of the at least a dopant forming a mixture;
producing a melt of molten glass from the mixture;
passing the molten glass along a tool to form a glass product, wherein the quartz product is in the form of a tubing, a rod, a blank, a strand, and wherein the wt. % is based on the total weight of the final mixture.

17. The process of claim 16, wherein the first blend is formed by mixing 0.04 to 0.30 wt. % of the dispersant with 0.1-8 wt. % of a dopant selected from the metal oxide group of Al₂O₃, CeO₂, Nd₂O₃, B₂O₃, CeO₂, BaO, SrO, CaO, MgO, TiO₂, Na₂O, K₂O, Li₂O, Sb₂O₃, and mixtures thereof,

18. The process of claim 17, wherein the first blend is formed by mixing 0.05 to 0.15 wt. % of the dispersant with 0.1-8 wt. % of a dopant selected from the metal oxide group of Al₂O₃, CeO₂, Nd₂O₃, B₂O₃, CeO₂, BaO, SrO, CaO, MgO, TiO₂, Na₂O, K₂O, Li₂O, Sb₂O₃, and mixtures thereof,

19. The process of claim 16, wherein the step of blending the first blend into 40 to 99 wt. % of SiO₂ forming a mixture further includes blending the first blend and the 40 to 99 wt. % of SiO₂ with 0.1-8 wt. % of a dopant selected from the metal oxide group of Al₂O₃, CeO₂, Nd₂O₃, B₂O₃, CeO₂, BaO, SrO, CaO, MgO, TiO₂, Na₂O, K₂O, Li₂O, Sb₂O₃, and mixtures thereof.

20. A quartz glass product, comprising 40 to 99 wt. % of SiO₂, 0.1-25 wt. % of at least a dopant selected from the metal oxide group of Al₂O₃, CeO₂, Nd₂O₃, B₂O₃, CeO₂, BaO, TiO₂, SrO, CaO, MgO, Na₂O, K₂O, Li₂O, Sb₂O₃, and mixtures thereof, and 0.04 to 0.30 wt. % of a fumed metal oxide having a BET of 50-400 m²/g and a mean particle size of <1 μm, and wherein the fumed metal oxide is SiO₂ or a metal oxide present in the dopant, and wherein the fumed metal oxide is first blended with 20-100% of the at least a dopant forming a master batch prior to blending with 40 to 99 wt. % of SiO₂ and any remainder of the at least a dopant.
